(19) United States
(12) Patent Application Publication
(10) Pub. No.: US 2016/0123226 A1
(43) Pub. Date: May 5, 2016

(54) GAS TURBINE USING A CRYOGENIC FUEL AND EXTRACTING WORK THEREFROM

(71) Applicant: ROLLS-ROYCE PLC, London (GB)

(72) Inventors: Ahmed RAZAK, Bristol (GB); Andrew Martin ROLT, Derby (GB)

(21) Appl. No.: 14/879,833

(22) Filed: Oct. 9, 2015

(30) Foreign Application Priority Data
Oct. 30, 2014 (GB) 1419329.6

(51) Int. Cl. F02C 3/22; F02C 7/224; F02C 3/04

(52) U.S. Cl. CPC F02C 3/22; F02C 3/04; F02C 7/224; F05D 2220/32; F05D 2210/11; F05D 2240/35; F05D 2260/20

(57) ABSTRACT

There is disclosed a method of operating a gas turbine engine of a type having a compressor section, a combustor section, and a turbine section arranged in flow series. The method involves the steps of: providing a supply of cryogenic liquid fuel; vaporising the cryogenic liquid fuel to produce a gaseous fuel; expanding said gaseous fuel in at least one fuel turbine external to the engine's turbine section; and thereafter directing said expanded gaseous fuel into the engine's combustion section for combustion therein. A related gas turbine arrangement configured for implementation of the method is also disclosed.

The present invention relates to a gas turbine arrangement, and to a related method of operating a gas turbine engine.

It has been proposed previously to operate gas turbine engines, such as those used to propel aircraft, by using two different types of fuels; either together simultaneously, or selectively during different periods of operation. In such regimes it is usual to use conventional fuel such as a kerosene-based fuel as a primary fuel, and to use a cheaper cryogenic fuel such a liquefied natural gas (LNG) or liquid hydrogen as a secondary fuel which is burned in the engine's combustors either simultaneously with the primary fuel, or as a substitute for the primary fuel during certain periods during the engine's operating cycle.

In such arrangements the cryogenic secondary fuel is stored at extremely low temperature such that it remains in the liquid phase. When required, the cryogenic fuel is vaporised into a gas and is then directed into the engine's combustor via series of fuel injectors, where it is then combusted, and the resultant hot combustion gases are then expanded through the engine's turbines in the normal manner.

By using cryogenic fuels in this manner, the performance of the gas turbine engine can be improved, and also the engine's combustion system can have a simpler and therefore more reliable design.

However, it has been found that significant inefficiencies can arise from this type of operating regime, and so further improvements are desirable.

It is therefore a first object of the present invention to provide an improved method of operating a gas turbine engine. It is another object of the present invention to provide an improved gas turbine arrangement.

According to a first aspect of the present invention, there is provided a method of operating a gas turbine engine having a compressor section, a combustor section, and a turbine section arranged in flow series, the method comprising the steps of: providing a supply of cryogenic liquid fuel; vaporising the cryogenic liquid fuel to produce a gaseous fuel; expanding said gaseous fuel in at least one fuel turbine external to the engine's turbine section; and thereafter directing said expanded gaseous fuel into the engine's combustion section for combustion therein.

Conveniently, the or each said fuel turbine is used to drive a load.

Advantageously, the engine's turbine section includes a turbine which is also configured to drive said load, such that the or each said fuel turbine is operable to augment the power output of the engine in driving said load.

Optionally, said gaseous fuel is expanded in a plurality of said fuel turbines arranged in flow series.

Preferably, said cryogenic liquid fuel is vaporized by being passed through a heat exchanger.

Optionally, said heat exchanger is an inlet cooler arranged to cool inlet air before the inlet air passes through the engine's compressor section.

Alternatively, said heat exchanger is an intercooler provided between successive engine compressors within the engine's compressor section.

Optionally, the method further includes the step of heating said expanded gaseous fuel after its expansion in the or each fuel turbine and prior to its combustion in the engine's combustion section.

Preferably, said expanded gaseous fuel is heated by using heat drawn from airflow through the engine's turbine section.

Advantageously, said expanded gaseous fuel is heated by being passed through a heat exchanger provided between successive engine turbines within the engine's turbine section.

Optionally, said expanded gaseous fuel is heated by being passed through a heat exchanger (38) provided downstream of the engine's turbine section.

Conveniently, the method further includes the step of heating said gaseous fuel to increase its temperature prior to its expansion in the or each fuel turbine.

Optionally, said gaseous fuel is heated to increase its temperature prior to its expansion in a first of said fuel turbines and is then heated again immediately prior to its expansion in each other fuel turbine.

Preferably, said gaseous fuel is heated by using heat drawn from airflow through the engine's turbine section.

Advantageously, said gaseous fuel is heated by being passed through a heat exchanger provided between successive engine turbines within the engine's turbine section.

Conveniently, said gaseous fuel is heated by being passed through a heat exchanger provided downstream of the engine's turbine section to receive exhaust gas from the engine's turbine section.

The pressure of said cryogenic liquid fuel is preferably increased prior to its vaporization.

Optionally, the pressure of said cryogenic liquid fuel is increased to a level above the fuel's critical pressure.

Conveniently, the pressure of said cryogenic liquid fuel is increased by a fuel pump provided in a fuel line for the passage of said cryogenic fuel.

Advantageously, another fuel, in addition to said cryogenic liquid fuel, is also burned in said combustor section.

According to another aspect of the present invention, there is provided a gas turbine arrangement including: a gas turbine engine having a compressor section, a combustor section, and a turbine section arranged in flow series; a supply of cryogenic liquid fuel; and a fuel delivery system configured to direct said fuel to the combustor section of the engine, wherein the fuel delivery system includes: a vaporiser configured to vaporise said cryogenic liquid fuel and thereby produce a gaseous fuel; and at least one fuel turbine external to the engine's turbine section and which is configured to expand said gaseous fuel prior to its delivery to the engine's combustor section.

Conveniently, the or each said fuel turbine is arranged to drive a load.

Advantageously, the engine's turbine section includes a turbine which is also arranged to drive said load, such that the or each said fuel turbine is operable to augment the power output of the engine in driving said load.

Optionally, the arrangement includes a plurality of said fuel turbines arranged in flow series.

Conveniently, said vaporiser is a heat exchanger.

Optionally, said heat exchanger is an inlet cooler arranged to cool inlet air before the inlet air passes through the engine's compressor section.

Alternatively, said heat exchanger is an intercooler provided between successive engine compressors within the engine's compressor section.

Optionally, said fuel delivery system is configured to heat said expanded gaseous fuel to increase its temperature after expansion in the or each fuel turbine and prior to its combustion in the engine's combustion section.

Preferably, said fuel delivery system includes a heat exchanger provided between successive engine turbines within the engine's turbine section.

Advantageously, said fuel delivery system includes a heat exchanger provided downstream of the engine's turbine section to receive exhaust gas from the engine's turbine section.

Conveniently, said fuel delivery system is configured to heat said gaseous fuel to increase its temperature prior to its expansion in the or each fuel turbine.

Preferably, said fuel delivery system includes a heat exchanger provided between successive engine turbines within the engine's turbine section.

Optionally, said fuel delivery system includes a heat exchanger provided downstream of the engine's turbine section to receive exhaust gas from the engine's turbine section.

Advantageously, the fuel delivery system includes a pump configured to increase the pressure of said cryogenic liquid fuel before it is directed to said vaporiser.

So that the invention may be more readily understood, and so that further features thereof may be appreciated, embodiments of the invention will now be described by way of example with reference to the accompanying drawings in which:

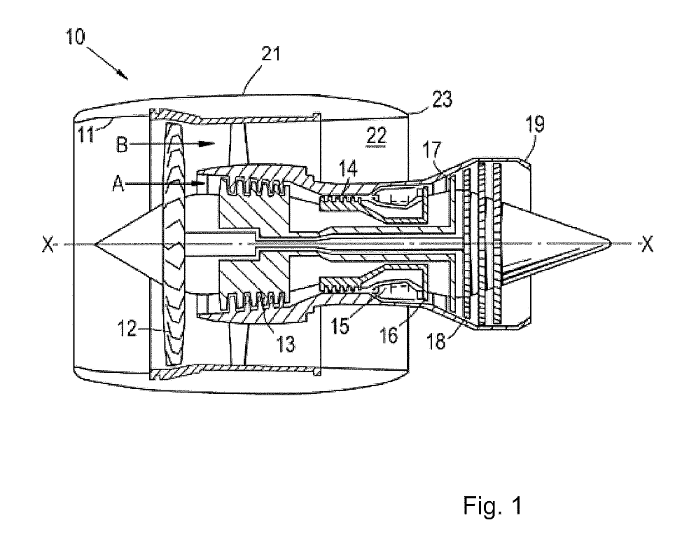

FIG. 1 is a schematic longitudinal cross-sectional view of one configuration of gas turbine engine suitable for use in embodiments of the present invention;

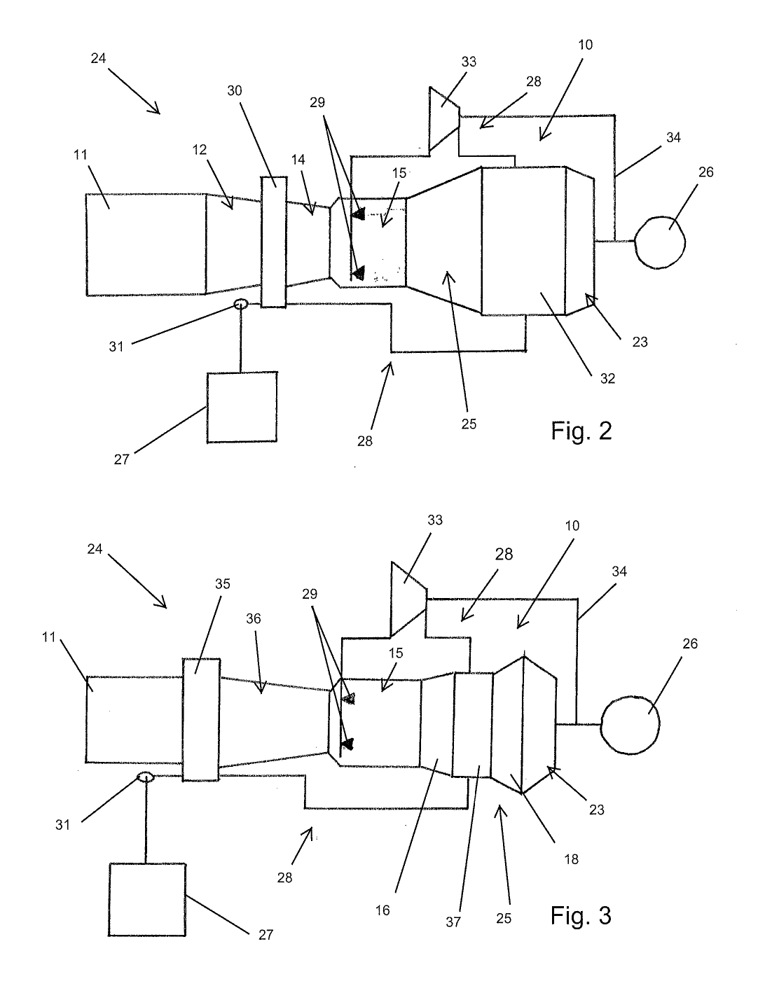

FIG. 2 is schematic illustration showing a gas turbine arrangement in accordance with one embodiment of the present invention;

FIG. 3 is a schematic illustration similar to that of FIG. 2, but which shows a gas turbine arrangement in accordance with another embodiment of the present invention; and

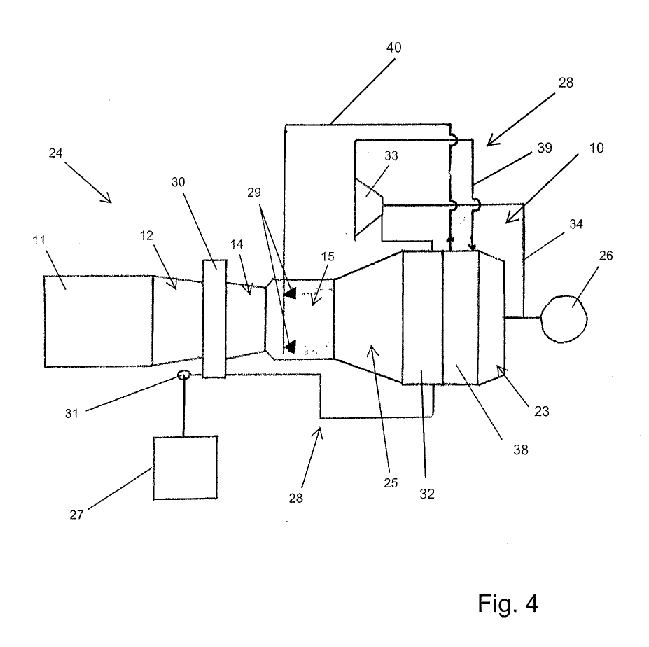

FIG. 4 is a another schematic illustration similar to that of FIG. 2, but which shows a gas turbine arrangement in accordance with a further embodiment of the present invention, and which may be considered to be a modification of the arrangement shown in FIG. 2.

Turning now to consider the drawings in more detail FIG. 1 illustrates an exemplary gas turbine of a ducted fan type typically used for aircraft propulsion, and which is suitable for use with the method and arrangement of the present invention. As will be explained, however, the present invention is not restricted to use with ducted fan gas turbine engines.

The engine is indicated generally at 10 and has a principal and rotational axis X-X. The engine comprises, in axial flow series, an air intake 11, a low pressure compressor in the form of a propulsive fan 12, an intermediate pressure compressor 13, a high-pressure compressor 14, combustion equipment 15, a high-pressure turbine 16, an intermediate pressure turbine 17, a low-pressure turbine 18 and a core engine exhaust nozzle 19. A nacelle 21 generally surrounds the engine 10 and defines the intake 11, a bypass duct 22 and a bypass exhaust nozzle 23.

During operation, air entering the intake 11 is accelerated by the fan 12 to produce two air flows: a first air flow A into the intermediate pressure compressor 13 and a second air flow B which passes through the bypass duct 22 to provide propulsive thrust. The intermediate pressure compressor 13 compresses the air flow A directed into it before delivering that air to the high pressure compressor 14 where further compression takes place.

The compressed air exhausted from the high-pressure compressor 14 is directed into the combustion equipment 15 where it is mixed with fuel and the mixture combusted. The resultant hot combustion products then expand through, and thereby drive the high, intermediate and low-pressure turbines 16, 17, 18 before being exhausted through the nozzle 19 to provide additional propulsive thrust. The high, intermediate and low-pressure turbines respectively drive the high and intermediate pressure compressors 14, 13 and the fan 12 by suitable interconnecting shafts.

As will therefore be appreciated by those of skill in the art, the low-pressure turbine 18 is arranged to drive the propulsive fan 12 by virtue of their interconnecting shaft. The fan 12 can thus be considered to represent a load which is driven by the low pressure turbine 18.

Whilst the engine illustrated in FIG. 1, and described briefly above, will be recognised as a so-called “three-shaft” engine having three discrete turbines which are connected to respective compressors by shafts, it is to be noted that the present invention may also be implemented with a so-called “two-shaft” engine having only two turbines; namely a high pressure turbine and a low pressure turbine, but with no intermediate pressure turbine therebetween.

It is also to be noted that the invention may be implemented with gas turbine engines of other configurations, or which are designed for different functions. For example, it is envisaged that the present invention may be used with a gas turbine engine configured for electrical power generation in which the engine's low pressure turbine 18 is arranged to drive a load in the form of a generator rather than the fan 12 of the propulsive engine illustrated in FIG. 1, for example via a suitable gearbox arrangement.

Turning now to consider FIG. 2, there is illustrated a gas turbine arrangement which is indicated generally at 24 and which incorporates a gas turbine engine 10. Various parts of the gas turbine engine 10 are illustrated and identified by the same reference numbers used above and in FIG. 1 to denote identical or equivalent parts of the engine. The engine thus has an intake 11, a low pressure compressor 12, a high pressure compressor 14, a combustor section 15, a turbine section 25 which comprises low and high pressure turbines, and an exhaust nozzle 23 arranged in axial flow series. The engine is illustrated schematically in FIG. 2 in a configuration in which its turbine section, and more particularly an individual turbine (not illustrated) therein is arranged to drive a load 26. The load 26 could be a generator or alternatively could be a propulsive fan as in the case of the engine illustrated in FIG. 1, or even a propeller in a marine installation.

In addition to the engine 10, the arrangement 24 further comprises a supply of cryogenic liquid fuel, illustrated schematically at 27. The supply 27 can be provided in the form of an insulated flask or tank which is configured to store cryogenic liquid fuel such as liquefied natural gas (“LNG”) or liquid hydrogen, at an extremely low temperature sufficient to maintain the fuel in its liquid phase within the tank.

The arrangement further comprises a fuel delivery system 28 which is configured to direct the cryogenic fuel from the supply 27 to the combustor section 15 of the engine for injection into the engine's combustion chamber via a series of fuel nozzles 29 therein. Further features of the fuel delivery system 28 are described below. It is to be noted at this juncture, however, that the fuel delivery system 28 is configured to direct only the cryogenic fuel into the engine's combustor section 15. The engine 10 will also have its own conventional fuel system which is configured to direct conventional jet fuel such as kerosene-based fuel into the engine's combustor section 15 in a conventional manner. The conventional fuel may thus be considered to represent a primary fuel, whereas the cryogenic fuel delivered via the fuel supply system 28 may be considered to represent a secondary fuel.

As illustrated in FIG. 2, the fuel delivery system includes a conduit which is arranged to direct fuel from the supply 27 to a vaporiser 30 in the form of a heat exchanger, via a pump 31 which may, as illustrated, be provided in a fuel line running from the supply 27 to the vaporiser 30. In the particular arrangement illustrated in FIG. 2, the vaporiser is provided in the form of an intercooler which is arranged between the low pressure compressor 12 and the high pressure compressor 14 within the engine's compressor section. The pump 31 is configured to draw liquid cryogenic fuel from the supply tank 27, increase its pressure, and deliver the fuel to the intercooler 30. The pump 31 may be configured to increase the pressure of the liquid fuel to approximately 200 bar, or even higher higher; for example above the critical pressure of the fuel.

As will be appreciated, the intercooler 30 takes the form of a heat exchanger and is thus configured to cool air exiting the low pressure compressor 12 before the air is directed into the high pressure compressor 14, and in doing so increases the temperature of the fuel directed through the intercooler, thereby vaporising the liquid fuel to produce a gaseous fuel.

The gaseous fuel produced via vaporisation of the cryogenic liquid fuel within the intercooler 30 is then directed from the intercooler 31 and into another heat exchanger 32, which in the embodiment illustrated in FIG. 2 is provided downstream of the engine's turbine section 25. The gaseous fuel is directed through the heat exchanger 32 which is thus configured to increase the temperature of the gaseous fuel by drawing heat from the exhaust gases exhausted from the engine's turbine section 25.

As illustrated at the top of FIG. 2, the gaseous fuel then exits the heat exchanger 32 and is directed into a fuel turbine 33. The fuel turbine is external to and separate from the engine's turbine section 25, and is configured to be driven by the flow of heated gaseous fuel directed through it, thereby expanding the gaseous fuel further. The fuel vapour exiting the fuel turbine 33 is then directed into the engine's combustor section, via the fuel nozzles 29, for combustion within the combustor section; either supplemental to the conventional fuel mentioned above, or instead of the conventional fuel.

It is to be noted that in the arrangement illustrated the fuel turbine is configured and arranged to drive the same load 26 as the engine's main turbine section 25, as illustrated schematically at 34. The power produced by the fuel turbine 33, from the heated gaseous fuel directed through it, is thus used to augment the power of the engine's main turbine section 25 in driving the load 26. The provision of the fuel turbine 33 as part of the secondary fuel delivery system 28, thus improves the efficiency of the overall arrangement in driving the load 26, because the secondary fuel is used to contribute to the power used to drive the load 26 both before combustion (by its expansion within the fuel turbine 33) and from its combustion within the engine's combustor (by expansion within the engine's main turbine section 25).

However, it also to be appreciated that in other embodiments of the invention, the fuel turbine 33 may be configured and arranged to drive other loads instead of the same load 26 as the engine's main turbine section. For example, the fuel turbine could instead be arranged to drive engine accessories such as the fuel pump 31 in arrangements where it is preferred that the fuel pump 31 is not driven by the engine's main turbine section 25.

Turning now to consider FIG. 3, there is illustrated an alternative embodiment of the gas turbine arrangement 24, where the same reference numbers are again used to denote similar or identical parts.

The arrangement 24 of FIG. 3 is similar to the arrangement described above and illustrated in FIG. 2 in several respects. However, in the arrangement of FIG. 3 it will be noted that the vaporiser is not provided in the form of an intercooler 30 as is the case in the arrangement of FIG. 1, but is instead provided in the form of an inlet cooler 35 which is arranged between the inlet 11 of the engine and the engine's compressor section 36. As will thus be appreciated, the vaporiser/inlet cooler 35 of this arrangement is configured to cool the inlet air drawn into the engine 10 before the air is directed into any of the compressors within the compressor section. Nevertheless, the inlet cooler 35 is still configured to increase the temperature of the cryogenic fuel directed through it, thereby vaporising the fuel to produce a gaseous fuel in a similar manner to the intercooler 30 of the FIG. 2 arrangement.

Another notable difference between the arrangement of FIG. 3 and the arrangement described above with reference to FIG. 2 is that the turbine exhaust gas heat exchanger 32 of the FIG. 2 arrangement is replaced with an inter-turbine heat exchanger 37 in the arrangement of FIG. 3. More particularly it will be noted that the heat exchanger 37 is positioned within the engine's turbine section 25, between the high pressure turbine 16 and the low pressure turbine 18. Nevertheless, the inter-turbine heat exchanger 37 is still configured to increase the temperature of the gaseous fuel passing through it via the fuel delivery system 28 by drawing heat from the exhaust gases exhausted from gas passing through the engine's turbine section 25.

It is to be noted that embodiments are also envisaged which combine the inter-turbine exhaust gas heat exchanger 37 principle of FIG. 3 with the intercooler 30 principle of FIG. 2, or which combine the inlet cooler 35 principle of FIG. 3 with the turbine exhaust gas heat exchanger 32 principle of FIG. 2.

Turning now to consider FIG. 4, there is illustrated a further alternative embodiment of the gas turbine arrangement 24, which can be considered to represent a modification of the arrangement illustrated in FIG. 2. However, as will be described, the same or similar modifications could also be made to the arrangement illustrated in FIG. 3. The same reference numbers are once more used to denote similar or identical parts.

The arrangement illustrated in FIG. 4 differs from that illustrated in FIG. 2 in that it actually includes two turbine exhaust gas heat exchangers 32, 38 which are arranged in exhaust flow series downstream of the engine's turbine section 25. The first of these heat exchangers 32 may be identical to the exhaust gas heat exchanger of the arrangement described above and illustrated in FIG. 2, and so is arranged to heat the gaseous fuel before it is directed into the fuel turbine 33 in a substantially identical manner. The second exhaust gas heat exchanger 38 may also be of similar or identical configuration, but is instead arranged to receive the expanded fuel vapour exiting the fuel turbine 33, as denoted by flow line 39 in FIG. 4. The expanded fuel vapour exiting the fuel turbine 33 is thus directed through the second exhaust gas heat exchanger 38, where in is reheated by drawing remaining heat from the exhaust gases exiting the engine's turbine section 25. The reheated fuel vapour is then directed from the second exhaust gas heat exchanger 38 into the engine's combustor section, via the fuel nozzles 29, as denoted by flow line 40, for combustion within the combustor section; again either supplemental to the engine's primary fuel, or instead of the primary fuel.

It is to be appreciated that a similar modification to reheat the fuel vapour exiting the fuel turbine 33 could also be made to the arrangement of FIG. 3. In such an arrangement the additional heat exchanger required to reheat the fuel vapour could be provided in the form of either another inter-turbine heat exchanger similar to the one described above and shown at 37 in FIG. 3, or in the form of an exhaust gas heat exchanger downstream of the engine's entire turbine section.

Whilst the invention has been described above with reference to specific embodiments, it is to be appreciated that various changes or modifications could be made without departing from the scope of the claimed invention. For example, in any of the above-described and illustrated embodiments it is envisaged that more than one fuel turbine 33 could be used to expand the heated gaseous secondary fuel, and hence drive the load to augment the power from the engine's turbine section. In such an arrangement, it is envisaged that a plurality of fuel turbines 33 could be arranged in flow series, such that the gaseous fuel is directed first through one fuel turbine, and then through one or more fuel turbines in turn, with the power generated by each fuel turbine being used to drive the load 26. In this type of arrangement it is envisaged that the fuel vapour leaving the or each fuel turbine 33 will be heated again (for example via passage through a turbine section exhaust heat exchanger 32 such as that illustrated in FIG. 2, or via passage through an inter-turbine heat exchanger 37 such as that illustrated in FIG. 3) before it is directed in the next successive fuel turbine 33.

More generally, whilst the above-described arrangements utilise the heat from the engine's exhaust gases to heat the gaseous secondary fuel before it is expanded in the or each fuel turbine 33, in other arrangements it is envisaged that other sources of heat could be used instead such as, for example, systems to cool the engine's turbine cooling air, or oil cooling systems.

When used in this specification and claims, the terms “comprises” and “comprising” and variations thereof mean that the specified features, steps or integers are included. The terms are not to be interpreted to exclude the presence of other features, steps or integers.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

1. A method of operating a gas turbine engine having a compressor section, a combustor section, and a turbine section arranged in flow series, the method comprising the steps of: providing a supply of cryogenic liquid fuel; vaporising the cryogenic liquid fuel to produce a gaseous fuel; expanding said gaseous fuel in at least one fuel turbine external to the engine's turbine section ; and thereafter directing said expanded gaseous fuel into the engine's combustion section for combustion therein.

2. A method according to claim 1, wherein the or each said fuel turbine is used to drive a load.

3. A method according to claim 2, wherein the engine's turbine section includes a turbine which is also configured to drive said load, such that the or each said fuel turbine is operable to augment the power output of the engine in driving said load.

4. A method according to claim 1, wherein said gaseous fuel is expanded in a plurality of said fuel turbines arranged in flow series.

5. A method according to claim 1, wherein said cryogenic liquid fuel is vaporized by being passed through a heat exchanger.

6. A method according to claim 5, wherein said heat exchanger is an inlet cooler arranged to cool inlet air before the inlet air passes through the engine's compressor section.

7. A method according to claim 5, wherein said heat exchanger is an intercooler provided between successive engine compressors within the engine's compressor section.

8. A method according to claim 1, further including the step of heating said expanded gaseous fuel after its expansion in the or each fuel turbine and prior to its combustion in the engine's combustion section.

9. A method according to claim 1, further including the step of heating said gaseous fuel to increase its temperature prior to its expansion in the or each fuel turbine.

10. A method according to claim 9, wherein said gaseous fuel is heated to increase its temperature prior to its expansion in a first of said fuel turbines and is then heated again immediately prior to its expansion in each other fuel turbine.

11. A method according to claim 1, wherein the pressure of said cryogenic liquid fuel is increased prior to its vaporization.

12. A method according to claim 11, wherein the pressure of said cryogenic liquid fuel is increased to a level above the fuel's critical pressure.

13. A method according to claim 11 wherein the pressure of said cryogenic liquid fuel is increased by a fuel pump provided in a fuel line for the passage of said cryogenic fuel.

14. A gas turbine arrangement including: a gas turbine engine having a compressor section, a combustor section, and a turbine section arranged in flow series; a supply of cryogenic liquid fuel; and a fuel delivery system configured to direct said fuel to the combustor section of the engine, wherein the fuel delivery system includes: a vaporiser configured to vaporise said cryogenic liquid fuel and thereby produce a gaseous fuel; and at least one fuel turbine external to the engine's turbine section and which is configured to expand said gaseous fuel prior to its delivery to the engine's combustor section.

15. A gas turbine arrangement according to claim 14, wherein the or each said fuel turbine is arranged to drive a load.

16. A gas turbine arrangement according to claim 14, having a plurality of said fuel turbines arranged in flow series.

17. A gas turbine arrangement according to claim 14, wherein said fuel delivery system is configured to heat said expanded gaseous fuel to increase its temperature after expansion in the or each fuel turbine and prior to its combustion in the engine's combustion section.

18. A gas turbine arrangement according to claim 14, wherein said fuel delivery system is configured to heat said gaseous fuel to increase its temperature prior to its expansion in the or each fuel turbine.

19. A gas turbine arrangement according to claim 14, wherein said fuel delivery system includes a heat exchanger provided downstream of the engine's turbine section to receive exhaust gas from the engine's turbine section.

20. A gas turbine arrangement according to claim 14, wherein the fuel delivery system includes a pump configured to increase the pressure of said cryogenic liquid fuel before it is directed to said vaporiser.
